(19) United States
(12) Patent Application Publication
(10) Pub. No.: US 2021/0345320 A1
(43) Pub. Date: Nov. 4, 2021

(54) APPARATUSES AND METHODS FOR ACQUIRING AND REPORTING RESOURCE NEEDS OF SHARED ACCESS POINTS (APS) FOR MULTI-AP COORDINATION

(71) Applicant: MEDIATEK INC., Hsinchu City (TW)

(72) Inventors: Ying-You LIN, Hsinchu City (TW); Ping-Chen LIN, Hsinchu City (TW)

(21) Appl. No.: 17/236,076

(22) Filed: Apr. 21, 2021

Related U.S. Application Data
(60) Provisional application No. 63/200,523, filed on Mar. 12, 2021.
(60) Provisional application No. 63/035,079, filed on Jun. 5, 2020.
(60) Provisional application No. 63/019,466, filed on May 4, 2020.

(51) Int. Cl. H04W 72/04; H04W 72/08

(52) U.S. Cl. CPC H04W 72/0426; H04W 72/087; H04W 72/0453; H04W 72/0446

(57) ABSTRACT

A method for acquiring and reporting resource needs of shared Access Points (APs) for multi-AP coordination is provided. A sharing AP transmits a control frame for Multi-AP coordination to a shared AP. The sharing AP receives a report on resource needs from the shared AP in response to the transmission of the control frame. The sharing AP allocates time-frequency resources of a Transmit Opportunity (TXOP) to the shared AP based on the report on resource needs.

### CROSS REFERENCE TO RELATED APPLICATIONS

This application claims priority under 35 U.S.C. § 119 from U.S. Provisional Application No. 63/019,466, entitled “C-TDMA and C-OFDMA resource need collection mechanisms”, filed on May 4, 2020; U.S. Provisional Application No. 63/035,079, entitled “C-TDMA and C-OFDMA Resource Need collection mechanisms”, filed on Jun. 5, 2020; U.S. Provisional Application No. 63/200,523, entitled “C-TDMA and C-OFDMA Resource Need collection mechanisms”, filed on Mar. 12, 2021, the subject matter of which is incorporated herein by reference.

### BACKGROUND OF THE APPLICATION

### Field of the Application

The application generally relates to wireless communications, and more particularly, to apparatuses and methods for acquiring and reporting resource needs of shared Access Points (APs) for multi-AP coordination.

### Description of the Related Art

As demand for ubiquitous computing and networking grows, various wireless technologies have been developed, including Wireless-Fidelity (Wi-Fi) which is a Wireless Local Area Network (WLAN) technology allowing mobile devices, such as a smartphone, a smart pad, a laptop computer, a portable multimedia player, an embedded apparatus, or the like, to obtain wireless services in a frequency band of 2.4 GHz, 5 GHz or 60 GHz.

The Institute of Electrical and Electronics Engineers (IEEE) 802.11be standard is the next-generation WLAN standard which is in the process of being formulated by Extremely High Throughput (EHT) study group. To improve the throughput of the 802.11be system, various candidate features are being discussed, including more efficient utilization of non-contiguous spectrum, multi-band/multi-channel aggregation and operation, Multiple Input Multiple Output (MIMO) protocol enhancements, and multi-Access Point (AP) coordination, etc. The basic idea of multi-AP coordination is to allow an AP (also called sharing AP) to share its time-frequency resources of an obtained Transmit Opportunity (TXOP) with its neighbor APs (also called shared APs). For time resource sharing in multi-AP coordination, a technique called Coordinated AP (CAP) Time Division Multiple Access (TDMA) (or referred to as C-TDMA) is employed in which an AP that obtains a TXOP after medium access contention among a number of APs may share the frequency resource of small TXOP duration chunks with its neighbor APs. For frequency resource sharing in multi-AP coordination, a technique called CAP Orthogonal Frequency Division Multiple Access (OFDMA) (or referred to as C-OFDMA) is employed in which an AP that obtains a TXOP after medium access contention among a number of APs may share the smaller frequency chunks with its neighbor APs in the duration of the TXOP.

However, in the IEEE 802.11 technical standards, many operation details of multi-AP coordination have not yet defined, especially regarding how to let the sharing AP know the resource needs of the shared APs.

A solution is sought.

### BRIEF SUMMARY OF THE APPLICATION

The present application proposes both an initiative mechanism and a non-initiative mechanism for the sharing AP to acquire the resource needs of one or more shared APs and for the shared AP(s) to report the resource needs for multi-AP coordination. Please note that the terms “initiative” and “non-initiative” are addressed from the perspective of the sharing AP.

In one aspect of the application, a method is provided, which comprises the following steps: transmitting a control frame for Multi-AP coordination to a shared AP by a sharing AP; receiving a report on resource needs from the shared AP by the sharing AP in response to the transmission of the control frame; and allocating time-frequency resources of a Transmit Opportunity (TXOP) to the shared AP by the sharing AP based on the report on resource needs. In one example of the initiative mechanism, the control frame is a poll frame for requesting the report on resource needs of the shared AP, or is a trigger frame comprising an indicator for requesting the report on resource needs of the shared AP. The control frame and the report on resource needs are transmitted and received, respectively, within or out of the TXOP. In one example of the non-initiative mechanism, the control frame is a trigger frame for triggering the shared AP to participate in a coordinated AP transmission, and the report on resource needs is received in a Trigger-Based Physical layer Protocol Data Unit (TB PPDU) responsive to the trigger frame (e.g., received in a Quality of Service (QoS) control field or an A-control subfield of a QoS Null frame or a QoS Data frame in the TB PPDU). The report on resource needs comprises any combination of the following: an amount of data to be transmitted; a preferred bitrate; a preferred bandwidth; a preferred frequency; a Wireless-Fidelity (Wi-Fi) Multimedia (WMM) Access Category (AC) of the data to be transmitted; and an upper bound for transmission latency.

In another aspect of the application, a method is provided, which comprises the following steps: receiving a control frame for Multi-AP coordination from a sharing AP by a shared AP; transmitting a report on resource needs to the sharing AP by the shared AP in response to receiving the control frame; and receiving allocation of time-frequency resources of a TXOP from the sharing AP by the shared AP in response to the transmission of the report on resource needs. In one example of the initiative mechanism, the control frame is a poll frame for requesting the report on resource needs of the shared AP, or is a trigger frame comprising an indicator for requesting the report on resource needs of the shared AP. The control frame and the report on resource needs are received and transmitted, respectively, within or out of the TXOP. In one example of the non-initiative mechanism, the control frame is a trigger frame for triggering the shared AP to participate in a coordinated AP transmission, and the report on resource needs is transmitted in a TB PPDU responsive to the trigger frame (e.g., transmitted in a QoS control field or an A-control subfield of a QoS Null frame or a QoS Data frame in the TB PPDU). The report on resource needs comprises any combination of the following: an amount of data to be transmitted; a preferred bitrate; a preferred bandwidth; a preferred frequency; a WMM AC of the data to be transmitted; and an upper bound for transmission latency.

In another aspect of the application, a sharing AP is provided, which comprises a wireless transceiver and a controller. The wireless transceiver is configured to perform wireless transmission and reception to and from a shared AP. The controller is configured to transmit a control frame for Multi-AP coordination to a shared AP via the wireless transceiver, receive a report on resource needs from the shared AP via the wireless transceiver in response to the transmission of the control frame, and allocate time-frequency resources of a TXOP to the shared AP via the wireless transceiver based on the report on resource needs. In one example of the initiative mechanism, the control frame is a poll frame for requesting the report on resource needs of the shared AP, or is a trigger frame comprising an indicator for requesting the report on resource needs of the shared AP. The control frame and the report on resource needs are transmitted and received, respectively, within or out of the TXOP. In one example of the non-initiative mechanism, the control frame is a trigger frame for triggering the shared AP to participate in a coordinated AP transmission, and the report on resource needs is received in a TB PPDU responsive to the trigger frame (e.g., received in a QoS control field or an A-control subfield of a QoS Null frame or a QoS Data frame in the TB PPDU). The report on resource needs comprises any combination of the following: an amount of data to be transmitted; a preferred bitrate; a preferred bandwidth; a preferred frequency; a WMM AC of the data to be transmitted; and an upper bound for transmission latency.

Other aspects and features of the present application will become apparent to those with ordinary skill in the art upon review of the following descriptions of specific embodiments of the apparatuses and methods for acquiring and reporting resource needs of shared APs for multi-AP coordination.

### BRIEF DESCRIPTION OF DRAWINGS

The application can be more fully understood by reading the subsequent detailed description and examples with references made to the accompanying drawings, wherein:

FIG. 1 is a block diagram of a wireless communication system according to an embodiment of the application;

FIG. 2 shows an exemplary format of a QoS Null/Data frame that carries the report on resource needs of a shared AP;

FIG. 3 is a block diagram illustrating an AP 300 according to an embodiment of the application;

FIG. 4 shows an example of coordinated AP transmission using the C-TDMA technique with four APs and a bandwidth of 80 MHz;

FIG. 5 shows an example of coordinated AP transmission using the C-OFDMA technique with four APs and a bandwidth of 80 MHz;

FIG. 6 is a flow chart illustrating a method for acquiring resource needs of shared APs for multi-AP coordination according to an embodiment of the application;

FIG. 7 is a flow chart illustrating a method for reporting resource needs of shared APs for multi-AP coordination according to an embodiment of the application;

FIG. 8 is a schematic diagram illustrating multi-AP coordination using the C-TDMA technique according to an embodiment of the application;

FIG. 9 is a schematic diagram illustrating multi-AP coordination using the C-OFDMA technique according to an embodiment of the application;

FIG. 10 is a schematic diagram illustrating multi-AP coordination using the C-OFDMA technique according to another embodiment of the application; and

FIG. 11 is a schematic diagram illustrating multi-AP coordination using the C-OFDMA technique according to another embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

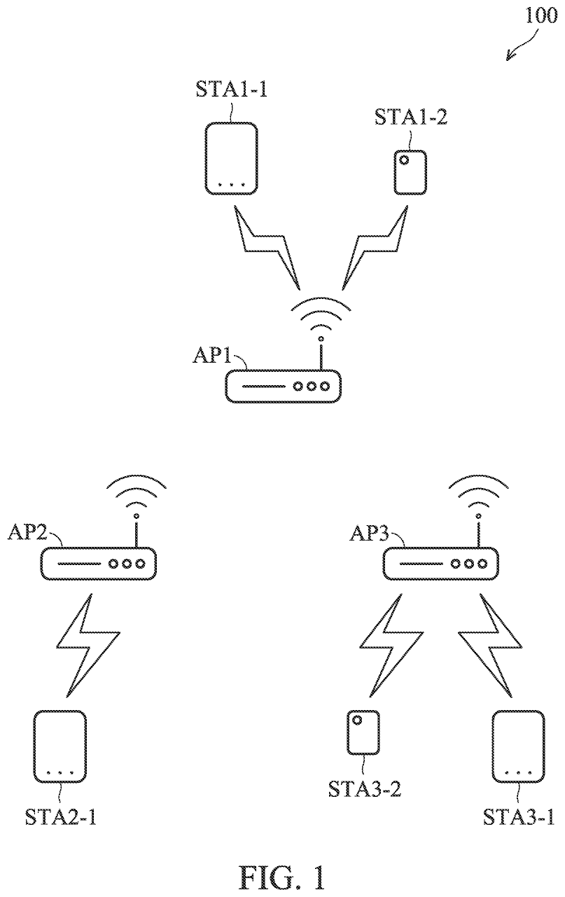

FIG. 1 is a block diagram of a wireless communication system according to an embodiment of the application.

As shown in FIG. 1, the wireless communication system 100 includes multiple Access Points (APs), e.g., APs 1˜3, in vicinity of each other (i.e., the coverage areas of AP1˜AP3 should overlap), and multiple STAs, e.g., STAs 1-1˜3-2, scattering throughout the coverage areas of AP1˜AP3.

Each of STAs 1-1˜3-2 may be a mobile phone (e.g., feature phone or smartphone), a panel Personal Computer (PC), a laptop computer, a desktop computer, a smart TV, or any wireless communication terminal, as long as it is compatible with the same IEEE 802.11 standard as AP1˜AP3. Each STA may operate in the non-AP mode to associate and communicate with one of AP1˜AP3 for uplink (UL) or downlink (DL) transmission.

Each of AP1˜AP3 is a wireless communication device compatible with IEEE 802.11 standards (e.g., IEEE 802.11be) to provide and manage the access to the wireless medium for other APs and/or the STA(s) in each AP's coverage. In one embodiment, each of AP1˜AP3 may be an Extremely-High Throughput (EHT) AP or an EHT STA operating in the AP mode, which is compatible with the IEEE 802.11be standard. In another embodiment, each of AP1˜AP3 may be an AP or an AP-mode STA which is compatible with any IEEE 802.11 standard later than 802.11be.

In particular, each of AP1˜AP3 supports coordinated AP transmission using the C-TDMA or C-OFDMA technique. That is, each of AP1˜AP3 is capable of operating as a sharing AP to share its time/frequency resource of an obtained Transmit Opportunity (TXOP) with other APs, and the shared APs may further allocate the shared time/frequency resource to the associated STAs for UL/DL transmission.

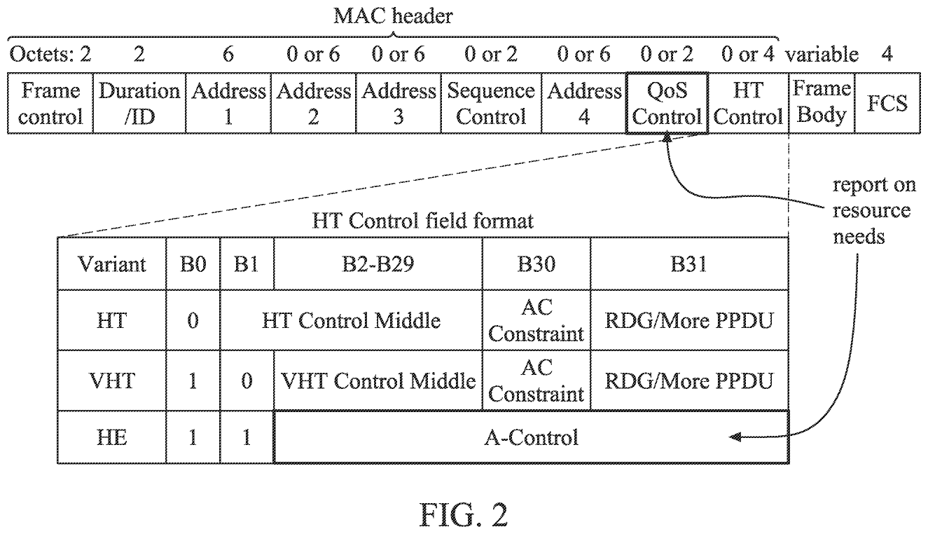

In accordance with one novel aspect, before performing coordinated AP transmission, the sharing AP may acquire the resource needs of the shared APs by applying a initiative mechanism and/or a non-initiative mechanism, so that the sharing AP may make better scheduling decisions of time/frequency resource allocation for the shared APs. In the initiative mechanism, the sharing AP may poll the shared APs to report their resource needs. For example, the sharing AP may transmit a poll frame (i.e., a type of control frame) to each shared AP, and each shared AP may respond to the poll frame by reporting its resource needs to the sharing AP. Alternatively, the sharing AP may transmit a trigger frame (i.e., a type of control frame) including an indicator (e.g., a bit, when set to ‘1’, means to request the reports on resource needs of the shared APs) to each shared AP, and each shared AP may respond to the poll frame by reporting its resource needs to the sharing AP. In the non-initiative mechanism, the sharing AP may trigger the shared APs for transmission and then await the PPDUs sent from the shared APs, which may carry the reports on resource needs of the shared APs. For example, the sharing AP may transmit a trigger frame (i.e., a type of control frame) for triggering the shared APs to participate in a coordinated AP transmission, and each shared AP may respond to the trigger frame by transmitting a Trigger-Based PPDU (TB PPDU) including a report of its resource needs to the sharing AP. In one embodiment, the report on resource needs may be carried in the Quality of Service (QoS) control field or A-control subfield of the QoS Null/Data frame in a TB PPDU. FIG. 2 shows an exemplary format of a QoS Null/Data frame that carries the report on resource needs of a shared AP.

Specifically, the report on resource needs may include any combination of the following: (1) the amount of data to be transmitted, (2) the preferred bitrate, (3) the preferred bandwidth, (4) the preferred frequency, (5) the Wi-Fi Multimedia (WMM) Access Category (AC) of data to be transmitted, and (6) the upper bound for transmission latency, etc.

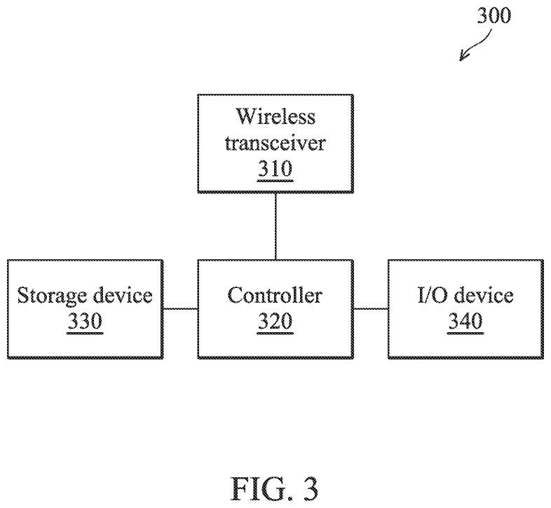

FIG. 3 is a block diagram illustrating an AP 300 according to an embodiment of the application.

As shown in FIG. 3, the AP 300 may include a wireless transceiver 310, a controller 320, a storage device 330, and an Input/Output (I/O) device 340.

The wireless transceiver 310 is configured to perform wireless transmission and reception to and from the other APs and one or more STAs.

For example, the wireless transceiver 310 may include a baseband processing device, a Radio Frequency (RF) device, and an antenna, wherein the antenna may include an antenna array for UL/DL Multi-User Multiple Input-Multiple-Output (MU-MIMO).

To further clarify, the baseband processing device may be configured to perform baseband signal processing, such as ADC/DAC, gain adjusting, modulation/demodulation, encoding/decoding, and so on, while the RF device may receive RF wireless signals via the antenna, convert the received RF wireless signals to baseband signals, which are processed by the baseband processing device, or receive baseband signals from the baseband processing device and convert the received baseband signals to RF wireless signals, which are later transmitted via the antenna.

The controller 320 may be a general-purpose processor, a Micro Control Unit (MCU), an application processor, a Digital Signal Processor (DSP), or the like, which includes various circuits for providing the functions of data processing and computing, controlling the wireless transceiver 310 for wireless communications with the other APs and one or more STAs, storing and retrieving data (e.g., program code) to and from the storage device 330, and receiving user inputs or outputting signals via the I/O device 340.

In particular, the controller 320 coordinates the aforementioned operations of the wireless transceiver 310, the storage device 330, and the I/O device 340 for performing the methods of the present application.

In another embodiment, the controller 320 may be incorporated into the baseband processing device of the wireless transceiver 310 to serve as a baseband processor.

As will be appreciated by persons skilled in the art, the circuits of the controller 320 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, Wi-Fi protocols (of the IEEE 802.11be standard or a more advanced version of the IEEE 802.11 standards), and/or the methods of the present application (which may be implemented as part of the Wi-Fi protocols).

The I/O device 340 may include one or more buttons, a keyboard, a touch pad, a display device (e.g., a Liquid-Crystal Display (LCD), a Light-Emitting Diode (LED) display, an Organic LED (OLED) display, or an Electronic Paper Display (EPD), etc.), a light emitting device, a microphone, and/or a speaker, etc., to serve as the Man-Machine Interface (MMI) for interaction with users.

It should be understood that the components described in the embodiment of FIG. 3 are for illustrative purposes only and are not intended to limit the scope of the application. For example, the AP 300 may include more components, such as a wired network interface (e.g., an Ethernet transceiver or a fiber optic transceiver) for providing wired network communication services, and/or a battery for powering the other components, etc.

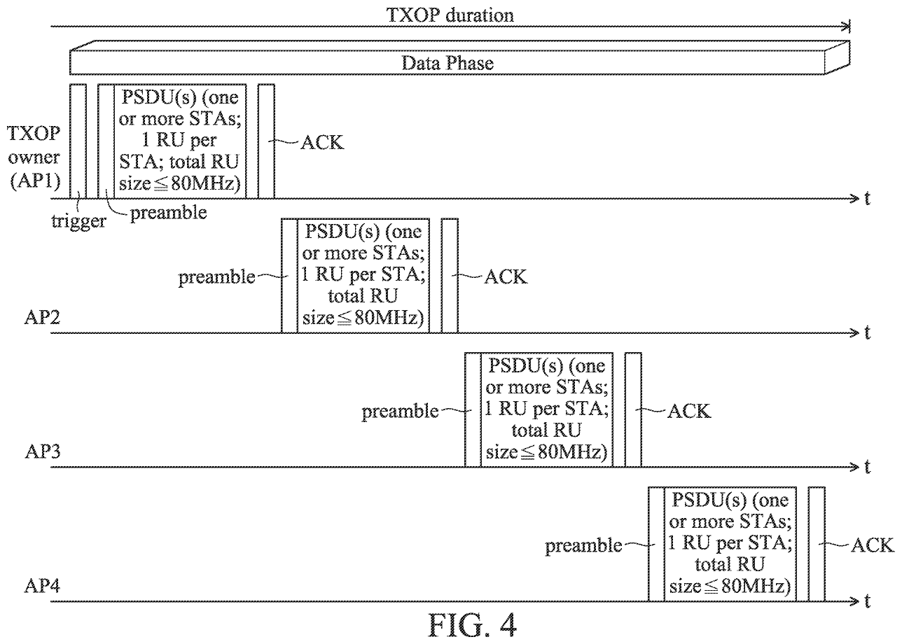

FIG. 4 shows an example of coordinated AP transmission using the C-TDMA technique with four APs and a bandwidth of 80 MHz.

As shown in FIG. 4, the sharing AP (i.e., the TXOP owner) and the shared APs (the other APs participating in the coordinated AP transmission) can only perform TDMA transmission in the allocated time-frequency resources within the TXOP duration. Each TDMA transmission is composed of one or more Physical layer Service Data Units (PSDUs) with one Resource Unit (RU) per STA of that AP.

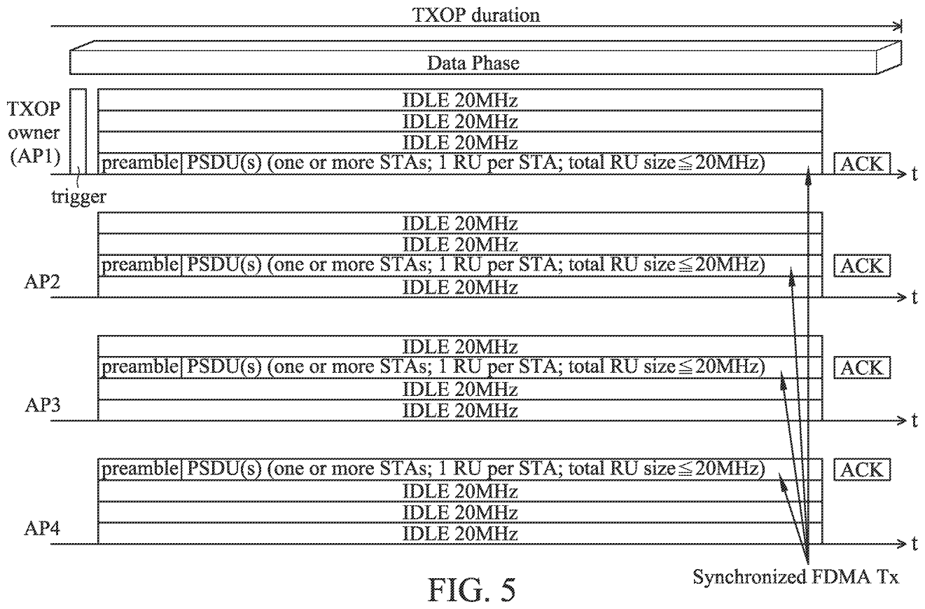

FIG. 5 shows an example of coordinated AP transmission using the C-OFDMA technique with four APs and a bandwidth of 80 MHz.

As shown in FIG. 5, the sharing AP (i.e., the TXOP owner) and the shared APs (the other APs participating in the coordinated AP transmission) perform FDMA transmission on their respective bandwidth allocated in the TXOP duration. Each synchronized FDMA transmission is composed of one or more PSDUs with one RU per STA of that AP. The synchronized FDMA transmission implies that each AP transmits a PPDU that is orthogonal to each other.

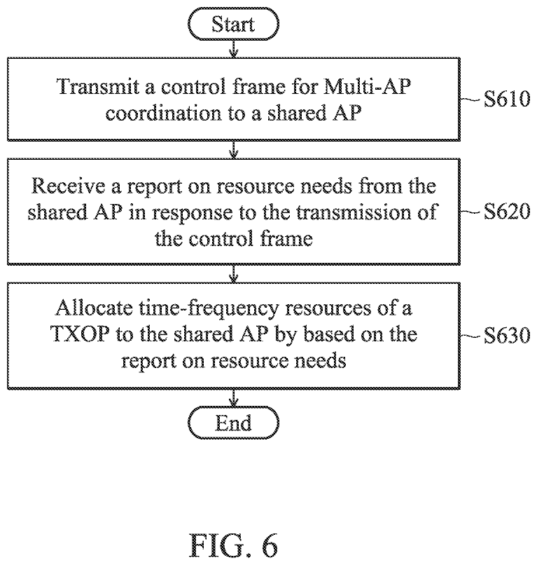

FIG. 6 is a flow chart illustrating a method for acquiring resource needs of shared APs for multi-AP coordination according to an embodiment of the application.

In this embodiment, the method for acquiring resource needs of shared APs for multi-AP coordination is applied to and executed by a sharing AP.

To begin with, in step S610, the sharing AP transmits a control frame for Multi-AP coordination to a shared AP.

Next, in step S620, the sharing AP receives a report on resource needs from the shared AP in response to the transmission of the control frame.

Specifically, the report on resource needs may include any combination of the following: (1) the amount of data to be transmitted, (2) the preferred bitrate, (3) the preferred bandwidth, (4) the preferred frequency, (5) the WMM AC of the data to be transmitted, and (6) the upper bound for transmission latency, etc.

After that, in step S630, the sharing AP allocates time-frequency resources of a TXOP to the shared AP by based on the report on resource needs.

In one example, if the initiative mechanism is applied, the control frame may be a poll frame for requesting the report on resource needs of the shared AP, or is a trigger frame including an indicator for requesting the report on resource needs of the shared AP. The control frame and the report on resource needs may be transmitted and received, respectively, within or out of the TXOP.

In another example, if the non-initiative mechanism is applied, the control frame may be a trigger frame for triggering the shared AP to participate in a coordinated AP transmission, and the report on resource needs may be received in a TB PPDU responsive to the trigger frame (e.g., received in a QoS control field or an A-control subfield of a QoS Null/Data frame in the TB PPDU). For instance, a TB PPDU may include one or more Media Access Control (MAC) PDUs (MPDUs), and each MPDU may include a QoS Null frame and/or QoS data frame(s) with the QoS control field or A-control subfield to carry the report on resource needs of the shared AP.

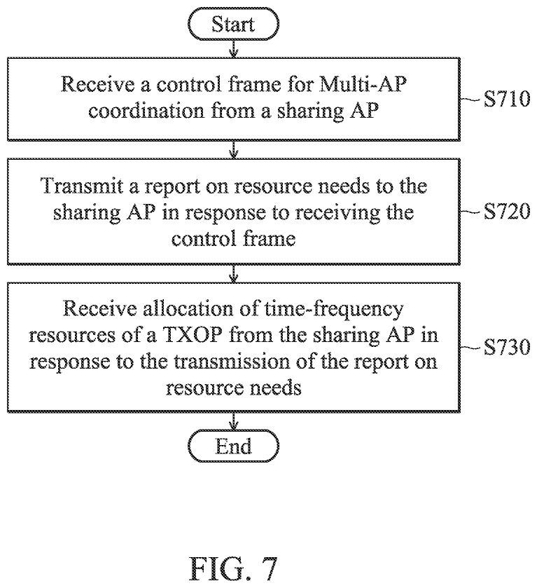

FIG. 7 is a flow chart illustrating a method for reporting resource needs of shared APs for multi-AP coordination according to an embodiment of the application.

In this embodiment, the method for reporting resource needs of shared APs for multi-AP coordination is applied to and executed by a shared AP.

To begin with, in step S710, the shared AP receives a control frame for Multi-AP coordination from a sharing AP.

Next, in step S720, the shared AP transmits a report on resource needs to the sharing AP in response to receiving the control frame.

Specifically, the report on resource needs may include any combination of the following: (1) the amount of data to be transmitted, (2) the preferred bitrate, (3) the preferred bandwidth, (4) the preferred frequency, (5) the WMM AC of data to be transmitted, and (6) the upper bound for transmission latency, etc.

After that, in step S730, the shared AP receives allocation of time-frequency resources of a TXOP from the sharing AP in response to the transmission of the report on resource needs.

In one example, if the initiative mechanism is applied, the control frame may be a poll frame for requesting the report on resource needs of the shared AP, or is a trigger frame including an indicator for requesting the report on resource needs of the shared AP. The control frame and the report on resource needs may be received and transmitted, respectively, within or out of the TXOP.

In another example, if the non-initiative mechanism is applied, the control frame may be a trigger frame for triggering the shared AP to participate in a coordinated AP transmission, and the report on resource needs may be transmitted in a TB PPDU responsive to the trigger frame (e.g., transmitted in a QoS control field or an A-control subfield of a QoS Null/Data frame in the TB PPDU). For instance, a TB PPDU may include one or more MPDUs, and each MPDU may include a QoS Null frame and/or QoS data frame(s) with the QoS control field or A-control subfield to carry the report on resource needs of the shared AP.

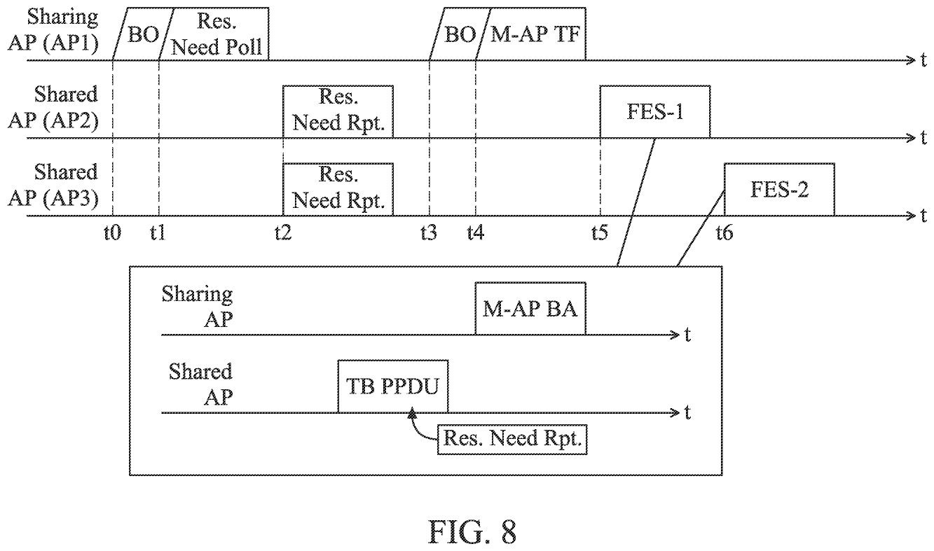

FIG. 8 is a schematic diagram illustrating multi-AP coordination using the C-TDMA technique according to an embodiment of the application.

In this embodiment, both the initiative mechanism and the non-initiative mechanism are applied for the sharing AP to acquire the resource needs of the sharing APs without using the channel control mechanism of TXOP.

At time t0, AP1 contends the medium access by waiting a back-off period (denoted as “BO” in FIG. 8).

At time t1, AP1 wins the medium access (i.e., AP1 becomes the sharing AP) due to the back-off period being relatively smaller than the back-off periods of the other APs, and transmits a poll frame (denoted as “Res. Need Poll” in FIG. 8) to the other APs (i.e., the shared APs) for requesting a report on resource needs of the shared APs.

At time t2, the shared APs respond to the poll frame by sending the reports of their resource needs (denoted as “Res. Need Rpt.” in FIG. 8) to the sharing AP.

At time t3, the sharing AP contends the medium access by waiting a back-off period again.

At time t4, the sharing AP wins the medium access and transmits a trigger frame (denoted as “M-AP TF” in FIG. 8) to the shared APs for triggering the shared APs to participate in a coordinated AP transmission for backhaul traffic (i.e., data communications between the APs). The trigger frame may include information indicating the time-frequency resources for the shared APs to use for transmission. For example, the trigger frame may indicate AP2 to start a Frame Exchange Sequence (FES) at time t5 and indicate AP3 to start an FES at time t6.

At time t5, AP2 starts an FES (denoted as “FES-1” in FIG. 8) with AP1 in response to the trigger frame. In FES-1, AP2 transmits a TB PPDU including backhaul traffic and a report of its resource needs to AP1 and AP1 replies to AP2 with a Block-ACK (BA) frame (denoted as “M-AP BA” in FIG. 8) for acknowledging the reception of the TB PPDU.

At time t6, an FES (denoted as “FES-2” in FIG. 8) between AP1 and AP3 begins with similar operations described in FES-1.

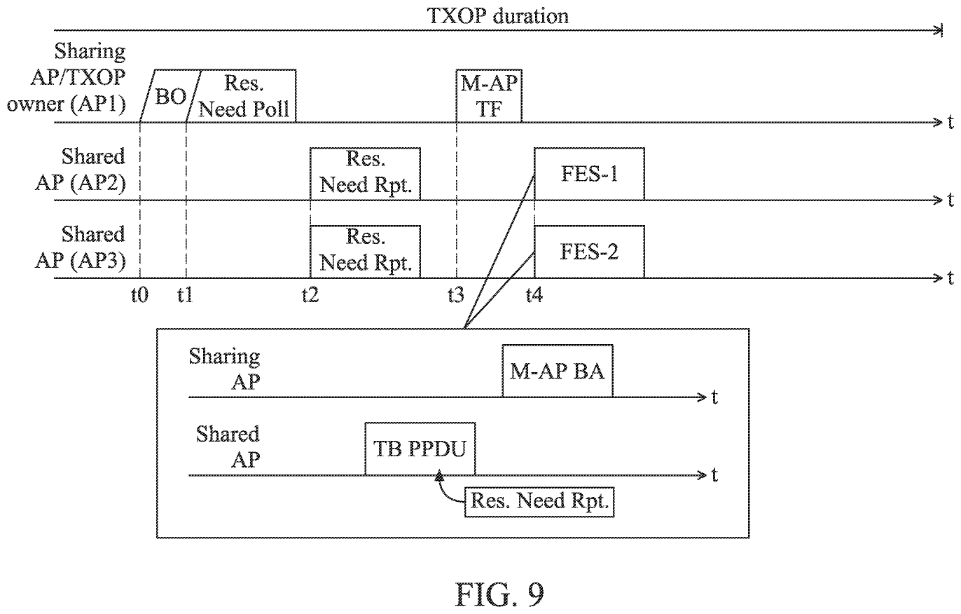

FIG. 9 is a schematic diagram illustrating multi-AP coordination using the C-OFDMA technique according to an embodiment of the application.

In this embodiment, both the initiative mechanism and the non-initiative mechanism are applied for the sharing AP to acquire the resource needs of the sharing APs within an obtained TXOP.

At time t0, AP1 (i.e., the sharing AP) waits a back-off period (denoted as “BO” in FIG. 9).

At time t1, AP1 transmits a poll frame (denoted as “Res. Need Poll” in FIG. 9) to the other APs (i.e., the shared APs) for requesting a report on resource needs of the shared APs.

At time t2, the shared APs respond to the poll frame by sending the reports of their resource needs (denoted as “Res. Need Rpt.” in FIG. 9) to the sharing AP.

At time t3, the sharing AP transmits a trigger frame (denoted as “M-AP TF” in FIG. 9) to the shared APs for triggering the shared APs to participate in a coordinated AP transmission for backhaul traffic (i.e., data communications between the APs). The trigger frame may include information indicating the time-frequency resources allocated for the shared APs to use for transmission. For example, the trigger frame may indicate each of AP2 and AP3 to start an FES at time t4 using different time-frequency resources.

At time t4, AP2 and AP3 each starts a respective FES (denoted as “FES-1” and “FES-2” in FIG. 9) with AP1 in response to the trigger frame. In each FES, the shared AP (i.e., AP2 or AP3) transmits a TB PPDU including backhaul traffic and a report of its resource needs to AP1 and AP1 replies to the shared AP with a BA frame (denoted as “M-AP BA” in FIG. 9) for acknowledging the reception of the TB PPDU.

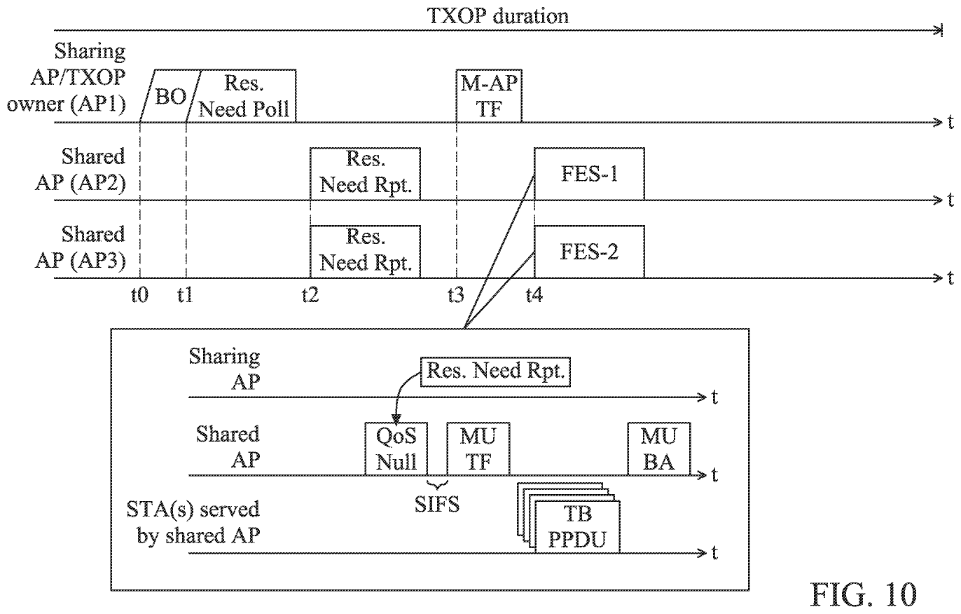

FIG. 10 is a schematic diagram illustrating multi-AP coordination using the C-OFDMA technique according to another embodiment of the application.

In this embodiment, both the initiative mechanism and the non-initiative mechanism are applied for the sharing AP to acquire the resource needs of the sharing APs within an obtained TXOP.

At time t0, AP1 waits a back-off period (denoted as “BO” in FIG. 10).

At time t1, AP1 transmits a poll frame (denoted as “Res. Need Poll” in FIG. 10) to the other APs (i.e., the shared APs) for requesting a report on resource needs of the shared APs.

At time t2, the shared APs respond to the poll frame by sending the reports of their resource needs (denoted as “Res. Need Rpt.” in FIG. 10) to the sharing AP.

At time t3, the sharing AP transmits a trigger frame (denoted as “M-AP TF” in FIG. 10) to the shared APs for triggering the shared APs to participate in a coordinated AP transmission for user traffic (i.e., data traffic between each shared AP and the STAs served by it). The trigger frame may include information indicating the time-frequency resources allocated for the shared APs to use for transmitting the reports of their resource needs and for scheduling user traffic among the STAs served by the shared APs. For example, the trigger frame may indicate each of AP2 and AP3 to start an FES at time t4 using different time-frequency resources.

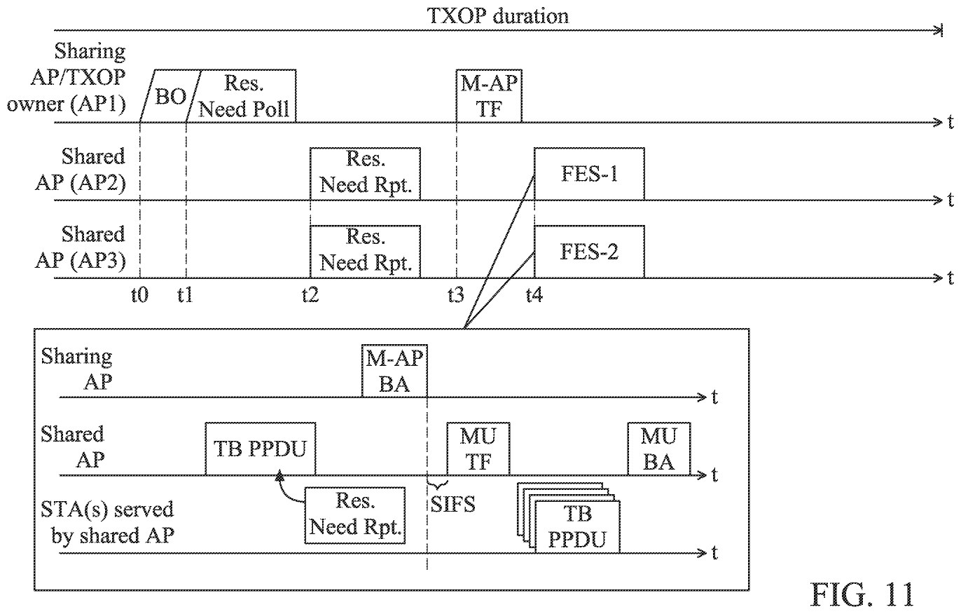

At time t4, AP2 and AP3 each starts a respective FES (denoted as “FES-1” and “FES-2” in FIG. 10) with AP1 in response to the trigger frame. In each FES, the shared AP (i.e., AP2 or AP3) transmits a QoS Null frame including a report of its resource needs to the sharing AP, and then triggers the STAs served by it for client traffic transmission using the allocated time-frequency resources. In another example, the shared AP may transmit multiple QoS Null/Data frames (e.g., in a TB PPDU), each of which may include a report of the resources needs of the shared AP, and each report may include the same or different resource needs of the shared AP. Specifically, the shared AP schedules the allocated time-frequency resources for the client traffic transmission of the STAs, and transmits an MU trigger frame (denoted as “MU TF” in FIG. 11) indicating the scheduled time-frequency resources for the STAs. Each STA uses the time-frequency resources scheduled for it to transmit a TB PPDU including the STA's traffic to the shared AP, and the shared AP replies to the STAs with a MU BA frame. In one example, the MU trigger frame may be a trigger frame with a trigger type subfield value=0 (indicating a basic trigger), while the MU BA frame may be a Multi-Station BA (MSBA) frame in a High Efficiency (HE) Single-User (SU) PPDU or may be multiple compressed BA frames in an HE Multi-User (MU) PPDU.

FIG. 11 is a schematic diagram illustrating multi-AP coordination using the C-OFDMA technique according to another embodiment of the application.

In this embodiment, both the initiative mechanism and the non-initiative mechanism are applied for the sharing AP to acquire the resource needs of the sharing APs within an obtained TXOP.

At time t0, AP1 waits a back-off period (denoted as “BO” in FIG. 11).

At time t1, AP1 transmits a poll frame (denoted as “Res. Need Poll” in FIG. 11) to the other APs (i.e., the shared APs) for requesting a report on resource needs of the shared APs.

At time t2, the shared APs respond to the poll frame by sending the reports of their resource needs (denoted as “Res. Need Rpt.” in FIG. 11) to the sharing AP.

At time t3, the sharing AP transmits a trigger frame (denoted as “M-AP TF” in FIG. 11) to the shared APs for triggering the shared APs to participate in a coordinated AP transmission for both backhaul and user traffic. The trigger frame may include information indicating the time-frequency resources allocated for the shared APs to use for backhaul and user traffic transmission. For example, the trigger frame may indicate each of AP2 and AP3 to start an FES at time t4 using different time-frequency resources.

At time t4, AP2 and AP3 each starts a respective FES (denoted as “FES-1” and “FES-2” in FIG. 11) with AP1 in response to the trigger frame. In each FES, the shared AP (i.e., AP2 or AP3) transmits a TB PPDU including backhaul traffic and a report of its resource needs to AP1 and AP1 replies to the shared AP with a BA frame (denoted as “M-AP BA” in FIG. 11) for acknowledging the reception of the TB PPDU. After that, the shared AP triggers the STAs served by it for client traffic transmission using the allocated time-frequency resources. Specifically, the shared AP schedules the allocated time-frequency resources for the client traffic transmission of the STAs, and transmits an MU trigger frame (denoted as “MU TF” in FIG. 11) indicating the scheduled time-frequency resources for the STAs. Each STA uses the time-frequency resources scheduled for it to transmit a TB PPDU including the STA's traffic to the shared AP, and the shared AP replies to the STAs with a MU BA frame. In one example, the MU trigger frame may be a trigger frame with a trigger type subfield value=0 (indicating a basic trigger), while the MU BA frame may be an MSBA frame in an HE SU PPDU or may be multiple compressed BA frames in an HE MU PPDU.

In view of the forgoing embodiments, it should be appreciated that the present application proposes well-defined and sophisticated mechanisms for the sharing AP to acquire the resource needs of the shared APs, so that the sharing AP may make better scheduling decisions of time/frequency resource allocation for the shared APs. Advantageously, the performance of coordinated AP transmission may be significantly improved.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A method, comprising:
transmitting a control frame for Multi-Access Point (AP) coordination to a shared AP by a sharing AP;
receiving a report on resource needs from the shared AP by the sharing AP in response to the transmission of the control frame; and
allocating time-frequency resources of a Transmit Opportunity (TXOP) to the shared AP by the sharing AP based on the report on resource needs.

2. The method as claimed in claim 1, wherein the control frame is a poll frame for requesting the report on resource needs of the shared AP, or is a trigger frame comprising an indicator for requesting the report on resource needs of the shared AP.

3. The method as claimed in claim 1, wherein the control frame and the report on resource needs are transmitted and received, respectively, within or out of the TXOP.

4. The method as claimed in claim 1, wherein the control frame is a trigger frame for triggering the shared AP to participate in a coordinated AP transmission.

5. The method as claimed in claim 4, wherein the report on resource needs is received in a Trigger-Based Physical layer Protocol Data Unit (TB PPDU) responsive to the trigger frame.

6. The method as claimed in claim 5, wherein the report on resource needs is received in a Quality of Service (QoS) control field or an A-control subfield of a QoS Null frame or a QoS Data frame in the TB PPDU.

7. The method as claimed in claim 1, wherein the report on resource needs comprises any combination of the following:
an amount of data to be transmitted;
a preferred bitrate;
a preferred bandwidth;
a preferred frequency;
a Wireless-Fidelity (Wi-Fi) Multimedia (WMM) Access Category (AC) of the data to be transmitted; and
an upper bound for transmission latency.

8. A method, comprising:
receiving a control frame for Multi-Access Point (AP) coordination from a sharing AP by a shared AP;
transmitting a report on resource needs to the sharing AP by the shared AP in response to receiving the control frame; and
receiving allocation of time-frequency resources of a Transmit Opportunity (TXOP) from the sharing AP by the shared AP in response to the transmission of the report on resource needs.

9. The method as claimed in claim 8, wherein the control frame is a poll frame for requesting the report on resource needs of the shared AP, or is a trigger frame comprising an indicator for requesting the report on resource needs of the shared AP.

10. The method as claimed in claim 8, wherein the control frame and the report on resource needs are received and transmitted, respectively, within or out of the TXOP.

11. The method as claimed in claim 8, wherein the control frame is a trigger frame for triggering the shared AP to participate in a coordinated AP transmission.

12. The method as claimed in claim 11, wherein the report on resource needs is transmitted in a Trigger-Based Physical layer Protocol Data Unit (TB PPDU) responsive to the trigger frame.

13. The method as claimed in claim 12, wherein the report on resource needs is transmitted in a Quality of Service (QoS) control field or an A-control subfield of a QoS Null frame or a QoS Data frame in the TB PPDU.

14. The method as claimed in claim 8, wherein the report on resource needs comprises any combination of the following:
an amount of data to be transmitted;
a preferred bitrate;
a preferred bandwidth;
a preferred frequency;
a Wireless-Fidelity (Wi-Fi) Multimedia (WMM) Access Category (AC) of the data to be transmitted; and
an upper bound for transmission latency.

15. A sharing Access Point (AP), comprising:
a wireless transceiver, configured to perform wireless transmission and reception to and from a shared AP; and
a controller, configured to transmit a control frame for Multi-AP coordination to a shared AP via the wireless transceiver, receive a report on resource needs from the shared AP via the wireless transceiver in response to the transmission of the control frame, and allocate time-frequency resources of a Transmit Opportunity (TXOP) to the shared AP via the wireless transceiver based on the report on resource needs.

16. The sharing AP as claimed in claim 15, wherein the control frame is a poll frame for requesting the report on resource needs of the shared AP, or is a trigger frame comprising an indicator for requesting the report on resource needs of the shared AP, or is a trigger frame for triggering the shared AP to participate in a coordinated AP transmission.

17. The sharing AP as claimed in claim 16, wherein the control frame and the report on resource needs are transmitted and received, respectively, within or out of the TXOP.

18. The sharing AP as claimed in claim 16, wherein the report on resource needs is received in a Trigger-Based Physical layer Protocol Data Unit (TB PPDU) responsive to the trigger frame.

19. The sharing AP claimed in claim 18, wherein the report on resource needs is received in a Quality of Service (QoS) control field or an A-control subfield of a QoS Null frame or a QoS Data frame in the TB PPDU.

20. The sharing AP as claimed in claim 15, wherein the report on resource needs comprises any combination of the following:
an amount of data to be transmitted;
a preferred bitrate;
a preferred bandwidth;
a preferred frequency;
a Wireless-Fidelity (Wi-Fi) Multimedia (WMM) Access Category (AC) of the data to be transmitted; and
an upper bound for transmission latency.
